(19) United States
(12) Patent Application Publication
(10) Pub. No.: US 2020/0326038 A1
(43) Pub. Date: Oct. 15, 2020

(54) CRYOGENIC SPECIMEN MANAGEMENT SYSTEM AND METHODS OF SECURING SENSITIZE DATA AND SERVICING COMPONENTS

(71) Applicant: Mark Ebrahim, Brooklyn, NY (US)

(72) Inventor: Mark Ebrahim, Brooklyn, NY (US)

(21) Appl. No.: 16/815,121

(22) Filed: Mar. 11, 2020

Related U.S. Application Data
(60) Provisional application No. 62/832,033, filed on Apr. 10, 2019.

(51) Int. Cl. F17C 3/08; F17C 1/00; A01N 1/02

(52) U.S. Cl. CPC F17C 3/08; F17C 1/00; F17C 2260/015; F17C 2223/0161; F17C 2270/0509; A01N 1/0257

(57) ABSTRACT

A method of servicing a cryo-EM storage system includes identifying an element of the storage system, the element including at least one of a dewar, a rack, a puck, a gridbox, and a grid, marking the element for additional action via a user device, and sending a request to another party via a network to perform the additional action.

### CROSS-REFERENCE TO RELATED APPLICATIONS

This application claims the benefit of U.S. Provisional Application Ser. No. 62/832,033, entitled “CRYOGENIC SPECIMEN MANAGEMENT SYSTEM AND METHODS OF SECURING SENSITIZE DATA AND SERVICING COMPONENTS,” filed on Apr. 10, 2019, the contents of which are hereby incorporated by reference.

### FIELD OF THE DISCLOSURE

The present disclosure relates storage and management of specimen. More specifically, it relates to devices and systems used to store, record, service, secure and analyze specimen in the field of electron microscopy.

### BACKGROUND OF THE DISCLOSURE

Common imaging technologies to observe and analyze specimens at the molecular and/or atomic level include optical, electron, x-ray and photon microscopy together with associated imaging and analysis. Cryo electron microscopy, or (“cryo-EM”) allows for the analysis of frozen hydrated biological specimen. In this technique, specimens are rapidly frozen and imaged in a fully hydrated native state, resulting in minimum artifacts and better image quality. Cryo-EM has gained popularity in studying proteins, viruses, macromolecular assemblies, vesicles/liposomes, organelles, and cells in more native conditions.

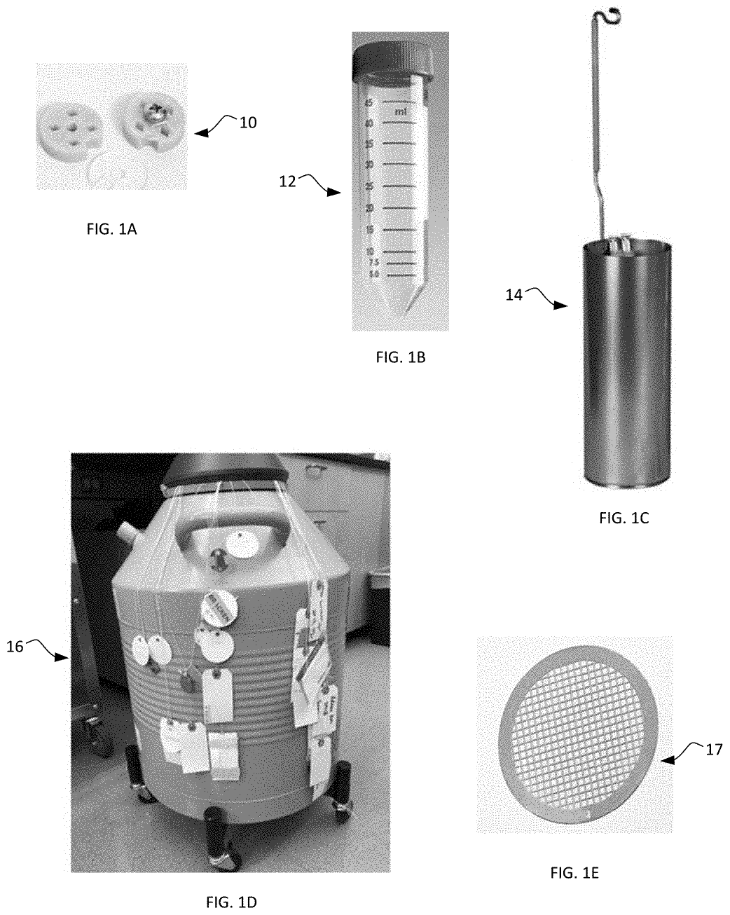

Cryo-EM facilities are typically used by multiple investigators, each pursuing their own research. Lab equipment is typically shared between multiple investigators. As shown in FIG. 1E, samples may be prepared on specimen support film/scaffold (i.e. cryo-EM grids), which in turn are stored in gridboxes 10. Each gridbox 10 typically holds a number of individual sample grids (FIG. 1A). The gridboxes are stored inside conical FALCON® tubes (FIG. 1B), which are placed into canisters 14 (FIG. 1C) and lowered into long-term liquid nitrogen storage dewars 16 (FIG. 1D). Each falcon tube is inserted and retrieved from the canister inside the dewar by a string having a label (See, FIG. 1D). To retrieve, identify and transport samples, the labels are first checked and then the appropriate sample is chosen. Traditionally, each investigator only tracks their own samples.

Thus, the current techniques are complicated and inconvenient. They are insecure because proprietary data is exposed. Additionally, there is an increased possibility of loss of samples or mixing of samples, and liability to the lab.

### SUMMARY OF THE DISCLOSURE

In at least some embodiments, a method of servicing a cryo-EM storage system includes identifying an element of the storage system, the element including at least one of a dewar, a rack, a puck, a gridbox, and a specimen support film, marking the element for additional action via a user device, and sending a request to another party via a network to perform the additional action.

In some examples, a method of ascertaining storage space in a cryo-EM storage system includes submitting a request via a user device to access an element of the storage system, the element including at least one of a dewar, a rack, a puck, a gridbox, and a grid, determining an available space within the element, and graphically displaying the available space.

A method of sharing information in a cryo-EM storage system includes identifying an element of the storage system, the element including at least one of a dewar, a rack, a puck, a gridbox, and a grid, marking the element for sharing with a receiving user via a user device; and sharing information relating to the element with the receiving user via a network.

### BRIEF DESCRIPTION OF THE DISCLOSURE

Various embodiments of the presently disclosed systems and methods are disclosed herein with reference to the drawings, wherein:

FIGS. 1A-E are photographs of elements used in cryo-EM including a gridbox, a falcon tube, a cannister a dewar, and a grid, respectively;

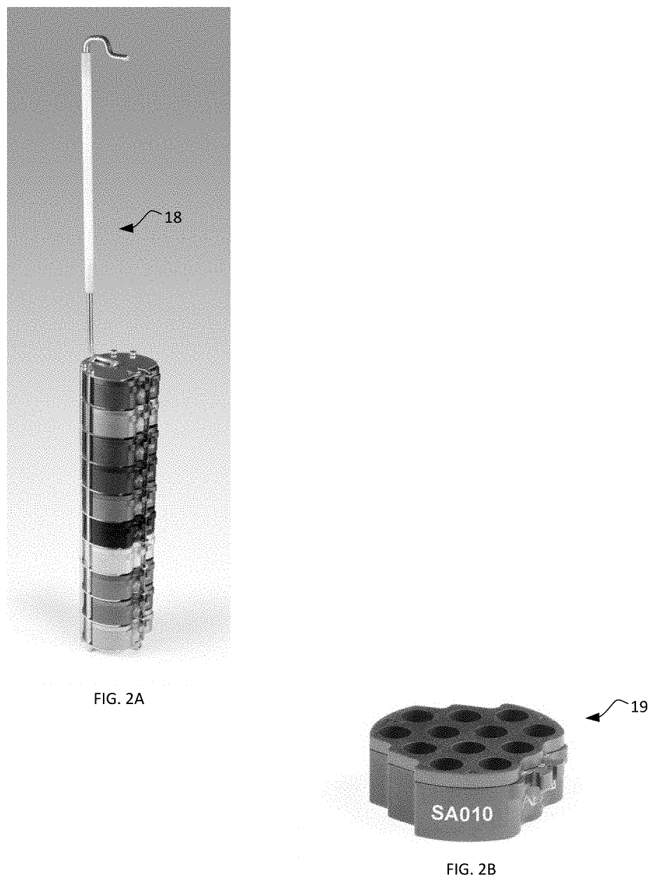

FIGS. 2A-B are photographs of a rack system having pucks, and a close-up photograph of a puck, respectively;

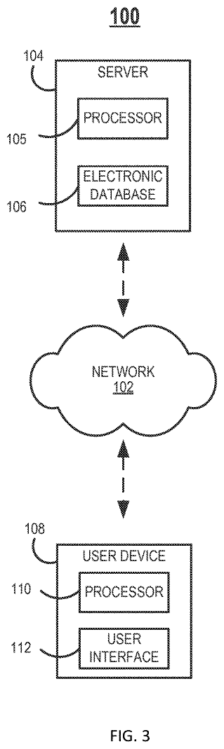

FIG. 3 is a schematic diagram of a system having a server, a network and a user device according to one aspect of the disclosure;

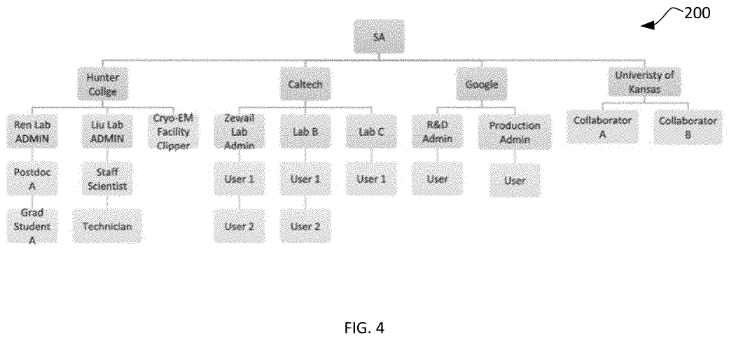

FIG. 4 is a schematic diagram of a hierarchal arrangement of different users arranged in a lab, and different labs arranged in group accounts;

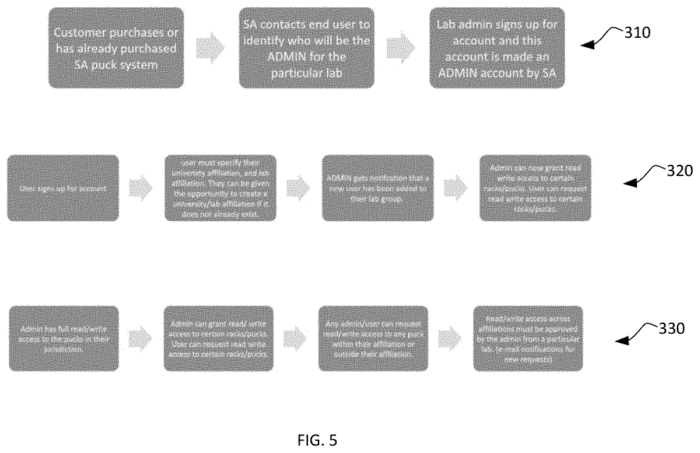

FIG. 5 illustrates schematic flowcharts showing various steps in adding administrator(s), adding user(s) and granting permission to users, respectively;

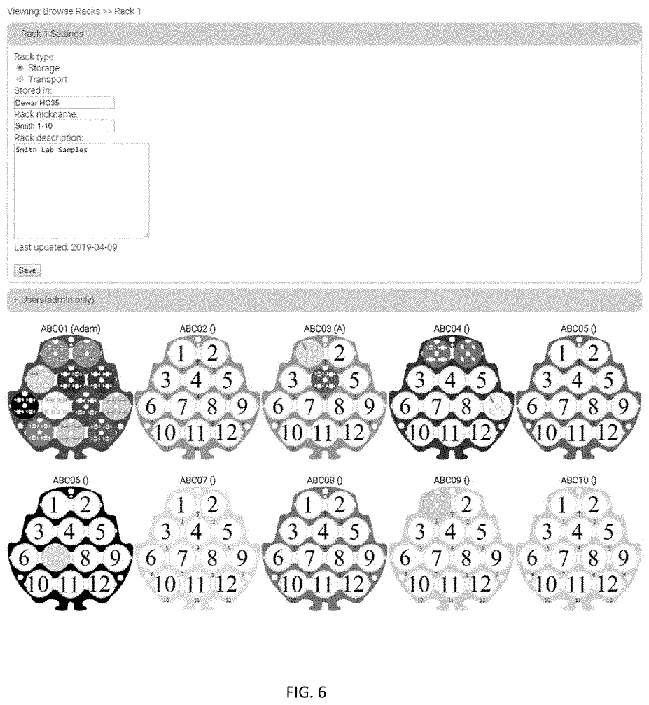

FIG. 6 is one example of a graphical interface showing a plurality of pucks within a rack;

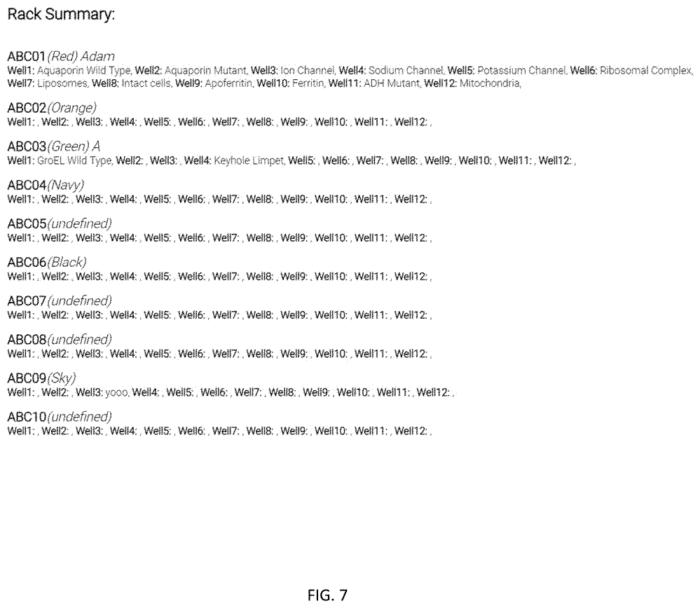

FIG. 7 is one example of a summary of information relating to the plurality of pucks of FIG. 6;

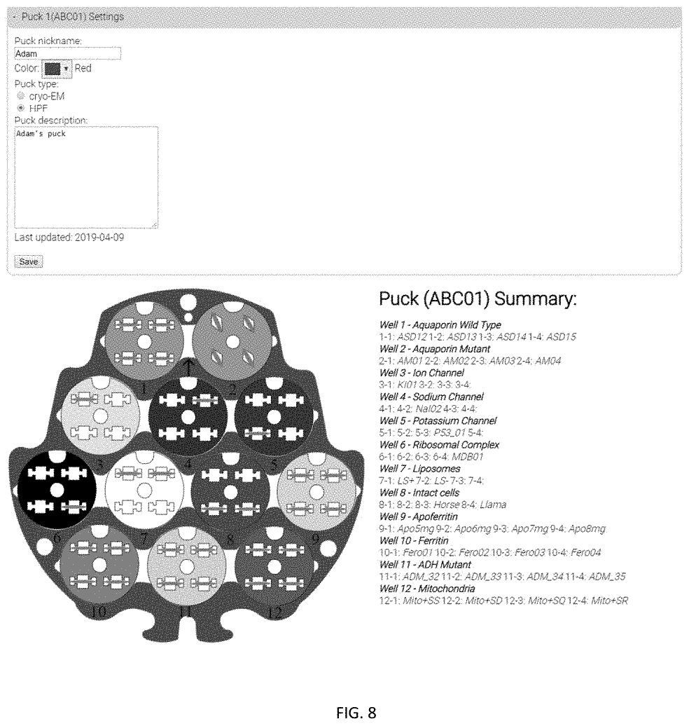

FIG. 8 is one example of a graphical interface showing a detailed view of a puck from the rack of FIG. 6; and

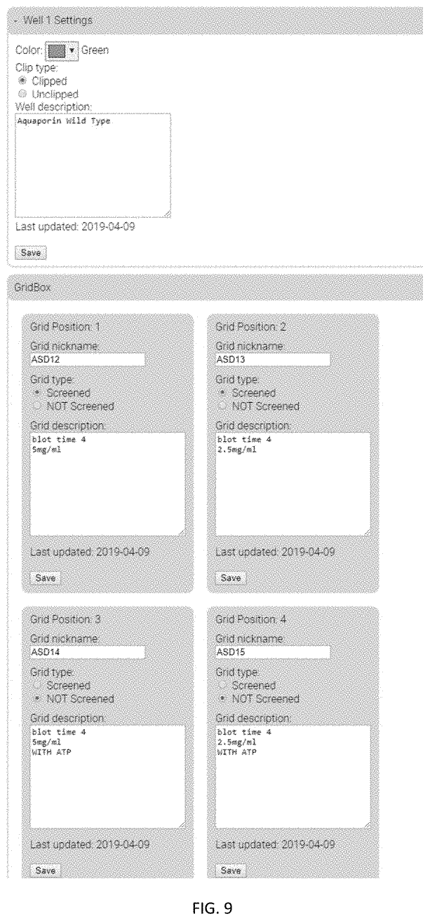

FIG. 9 is a detailed view of information in a gridbox in one of the wells of the puck of FIG. 8.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to the field of cryo-EM, conventional methods suffer from some shortcomings as discussed above. There therefore is a need for further improvements to the systems, devices and methods used to help facilitate the storing, security and ease-of-access of samples during cryo-EM. Among other advantages, the present disclosure may address one or more of these needs.

FIGS. 2A-B illustrates a rack-and-puck system used to replace the conical falcon tubes and cannisters of the prior art. Rack 18 generally includes an elongated handle that extends to form a brace, the brace having a plurality of stacked compartments. In at least some examples, the rack includes ten compartments as shown, although it will be understood that any number of compartments may be formed. Each of the compartments may releasably house a puck 19. As shown in FIG. 2B, each puck includes a number of wells (e.g., 12 wells), each well being sized to receive a gridbox. The gridbox will includes multiple specimen support films (e.g., a grid). The word “grid” will be used throughout the disclosure, but it will be understood that other support films are possible, and that were the term “grid” is recited, other variations of support films are intended as well. The pucks may be engraved on a front end with a serial number, name, experiment or other identifying information. Additionally, the pucks may be color-coded as shown, each puck having a different color to quickly distinguish one from another.

In some embodiments, network and database structures are formed to collect, store, service, display, and/or answer queries related to a specific cryo-EM system. FIG. 3 depicts examples of network and database structures that may be used to implement the systems and methods disclosed herein. The system 100 includes a server 104 and a user device 108 connected over a network 102 to the server 104. The server 104 includes a processor 105 and an electronic database 106, and the user device 108 includes a processor 110 and a user interface 112. As used herein, the term “processor” or “computing device” refers to one or more computers, microprocessors, logic devices, servers, or other devices configured with hardware, firmware, and software to carry out one or more of the computerized techniques described herein. Processors and processing devices may also include one or more memory devices for storing inputs, outputs, and data that is currently being processed.

As used herein, “user interface” includes, without limitation, any suitable combination of one or more input devices (e.g., keypads, touch screens, trackballs, voice recognition systems, optical character recognition, infrared sensors, radio frequency sensors etc.) and/or one or more output devices (e.g., visual displays, speakers, tactile displays, printing devices, etc.). As used herein, “user device” includes, without limitation, any suitable combination of one or more devices configured with hardware, firmware, and software to carry out one or more of the computerized techniques described herein. Examples of user devices include, without limitation, personal computers, laptops, and mobile devices (such as smartphones, blackberries, PDAs, tablet computers, etc.). Only one server and one user device are shown in FIG. 3 to avoid complicating the drawing, but the system 100 can support multiple servers and multiple user devices, which may be connected over one or more networks.

A user may provide one or more inputs, such a description of a sample and its associated grid, gridbox, puck, rack and/or dewar, to the system 100 via the user interface 112. The processor 110 may process the data corresponding to the user inputs before transmitting the user inputs to the server 104 over the network 102. For example, the processor 110 may package the information with a timestamp or encode the information using specific pre-defined cryo-EM program codes. The electronic database 106 stores the user inputs, and may track not only the data but the user and the time/date of edit so that a historical account of the database is stored.

The components of the system 100 of FIG. 3 may be arranged, distributed, and combined in any of a number of ways. For example, multiple processing and storage devices may be connected via a network. Such an implementation may be appropriate for distributed computing over multiple communication systems including wireless and wired communication systems that share access to a common network resource. In some implementations, the system is implemented in a cloud computing environment in which one or more of the components are provided by different processing and storage services connected via the Internet or other communications system. The system may include a distributed system of servers that includes server instances, each including processor instances, respectively. The server instances may be, for example, virtual servers instantiated in a cloud computing environment.

As noted above, the system 100 may be robust enough to allow multiple users, and the users may be arranged in hierarchies 200 as shown in FIG. 4. Specifically, the hierarchy may include a database manager (marked in FIG. 4 as “SA”), under which a number of cryo-EM group accounts (e.g., corporations, universities, non-profits, etc.) are arranged. Each group account may have one or more labs, and each lab may include a number of users. Each user may be assigned a unique user name and password. Access to the information in the databases may be limited by where the user is positioned within the hierarchy. For example, users within a group account may only be limited to information relating to that group account, and to no other group. Likewise, users within a lab may have access to data from their own labs and/or access to data from other labs within the same group account. These preferences may be set by a group account administrator and, if needed, a lab administrator.

Each user may have access to only their own data, or to their data as well as data from other users within their lab, or to data from other users within their group account. In some examples, each user can also adjust their privacy settings to make their data private to only themselves, to their lab, to the group account, or to the public. In such cases, changing a privacy setting to make data less secure (i.e., by allowing more sharing of the data) may require approval from an administrator positioned higher up within the hierarchy. Thus, a user change in privacy may require lab approval, and/or group account approval.

FIG. 5 illustrates examples of flowcharts showing certain protocols. First, a customer may purchase a suitable rack-puck system. The user is contacted by the application manager to identify or create a group account and/or a lab and to select and administrator for the group and/or the lab. Alternatively, the user may create a new group account/lab and be appointed the administrator of the group account and/or lab (310).

If a group account and/or lab already exists, the user may sign up for an account and specify their group account/lab affiliation and lab, to validate the identity of the user. A request is sent to the administrator of the group account/lab and the user may be granted access to certain rack-puck systems and possible read and/or write access to the rack-puck systems within one or more labs, or to the entirety of the group account(320).

Third, an existing user may request read and/or write access to certain racks-pucks from within their lab, or within their group account, or from an unaffiliated group account. The administrator of the rack-puck may approve or reject the request (330). In this manner, collaboration is possible between different universities and/or labs. Alternatively, a user may request to share information with another user and the request may be approved or denied by the administrator.

In some examples, the system may graphically display information to the user. The amount and/or type of information displayed will correspond to the level of access given to a user and their place in the hierarchy above. As shown in FIG. 6, a user may access a specific dewar (e.g., Dewar HC35). Within the specific dewar, the user may access a specific rack (e.g., “Smith 1-10”). Once the rack is virtually “opened,” the contents of each of the pucks may be displayed as shown in FIG. 6. Each puck may have a title (e.g., ABC01) associated with it. Additionally, each puck may have a username (e.g., “Adam”) associated with it.

Each of the graphical displays of the pucks may be color-coded to match the color of the physical puck so that quick correspondence is possible. Additionally, each of the gridboxes within the wells of a puck may be likewise color-coded to match the color and style of the physical gridbox. A numerical display 1-12 may indicate that a specific well within a puck is empty. Alternatively, an empty well may be “grayed out” reflecting an empty space. In this manner, it is easy to quickly see, for example, that puck ABC05 is completely empty, and that puck ABC03 has two grid boxes in wells 1 and 4. Subsequently, it can be seen which positions of the grid boxes in wells 1 and 4 are occupied with grids.

A rack summary may also be displayed (FIG. 7), which gives a brief overview of all the pucks within the rack, their names, and their contents. Moreover, each puck may be accessed and linked to a more detailed view of the contents of the puck (FIG. 8), and each gridbox within a puck, may be further accessed so that the contents of each gridbox, and each grid within the gridbox may be edited or read (FIG. 9). The user may add information on each grid, or each gridbox. For example, the user may select whether the gridbox is clipped or unclipped, or whether each grid position is screened or not screened. Additionally, the user may add information on the type and/or nature of the sample, the preparation of the sample (e.g., freezing conditions), the results of the screening process such as information relating to ice thickness, homogeneity, whether the sample is monodispersed, and other factors.

Available Locations

In some examples, the system may include a search feature to perform a query at the group account level, the lab level or for a specific user of an element (e.g., a dewar, a rack, a puck, a gridbox, and/or a grid). For example, a user or administrator may search for all available dewars within a lab, and the system may return a listing of all dewars that have availability for a new rack. Alternatively, the system may return a listing of all racks that have “open” puck(s) (i.e., an empty compartment within a rack, or a puck with all open wells), or all pucks that have available wells. In some examples, instead of a search, a graphical representation of the elements may be used to quickly display the elements, such as the empty wells within each puck of a rack, and/or the empty pucks within each rack. In this manner, a user may quickly identify the available locations and store the samples in those locations without having to physically open each dewar, each rack and/or each puck to identify available positions.

Ownership

Inferior samples are often retained even when they have little to no value. This may include for example, samples that have been screened, but deemed of low quality during the screening process. It may also include samples that are in a dewar but whose ownership has been lost so that become unclaimed. Unclaimed samples and inferior ones take up valuable space within a dewar and undesirably increase the cost of maintaining the lab. In at least some examples, the system may be searchable by user so that all of the samples attributable to one user may be quickly identified. These samples may be displayed graphically. By reviewing ownership of samples, unclaimed samples may be quickly identified and an inquiry may be made into the owner, reducing the risk of lost samples. Additionally, the query may show that a particular user is hoarding samples, and the administrator may request that the user justify the use of the space, or clean out old samples to make room for others. If a user leaves the group or his research, the user's samples may be identified, processed, shipped or discarded as necessary. The information may remain available even after the user has changed organization so that no unclaimed samples remain within storage.

Servicing

Within the system, a user may request servicing of samples by sending a request to another user or another party to perform an action on a dewar, a rack, a puck, a gridbox or a grid. For example, a user may request that a gridbox be clipped to be prepared for imaging, and a third-party, such an independent contractor, may receive the request and perform the action, by for example, clipping all the requested samples according to a preset protocol. Additionally, the user may mark certain samples to be discarded (e.g., older samples, samples that have been screened and found to be deficient), and the third-party may discard all the unwanted samples. A user may also request that a specific dewar by topped up with liquid nitrogen, or that a rack be fixed or replaced. The third-party may perform the action and then clear the request, or they may send a message back to the user to request further information or to clarification on the service to be performed. Administrators may also request such servicing of the elements on behalf of a whole lab or a group account. In this way, services and maintenance may be performed by one person within a lab.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

1. A method of servicing a cryo-EM storage system comprising:
storing an element of the storage system within a database, the element including at least one of a dewar, a rack, a puck, a gridbox, and a grid;
identifying the element within the database;
marking the element for additional action via a user device; and
sending a request to another party via a network to perform the additional action.

2. The method of claim 1, wherein the element is a gridbox, and wherein the additional action includes clipping the gridbox.

3. The method of claim 1, wherein the element is a grid, and wherein the additional action includes screening the grid.

4. The method of claim 1, wherein the element is a grid, and wherein the additional action includes discarding a sample within the grid.

5. The method of claim 1, wherein the element is a rack, and wherein the additional action includes fixing or replacing the rack.

6. The method of claim 1, wherein the element is a puck, and wherein the additional action includes fixing or replacing the puck.

7. The method of claim 1, wherein the element is a dewar, and wherein the additional action includes adding liquid nitrogen to the dewar.

8. The method of claim 1, further comprising the step of receiving the request and marking the request as completed after performing the additional action.

9. The method of claim 1, further comprising the step of sending a message relating to the request.

10. A method of ascertaining storage space in a cryo-EM storage system comprising:
storing an element of the storage system within a database, the element including at least one of a dewar, a rack, a puck, a gridbox, and a grid;
submitting a request via a user device to access the element;
determining an available space within the element; and
graphically displaying the available space.

11. The method of claim 10, wherein the element is a dewar and determining an available space includes determining whether an additional rack may be added to the dewar.

12. The method of claim 10, wherein the element is a rack and determining an available space includes determining whether the rack has an open compartment to receive a puck, or a puck has no samples in it.

13. The method of claim 10, wherein the element is a puck, and determining an available space includes determining whether the puck has an open well to receive a gridbox, or whether the puck houses a gridbox that has no samples in it.

14. The method of claim 10, wherein the element is a gridbox, and determining an available space includes determining whether the gridbox has an available position to receive a grid.

15. The method of claim 10, wherein graphically displaying the available space includes displaying a replica of the element and identifying a corresponding available space on the element.

16. A method of sharing information in a cryo-EM storage system comprising:
storing an element of the storage system within a database, the element including at least one of a dewar, a rack, a puck, a gridbox, and a grid;
identifying the element within the database;
marking the element for sharing with a receiving user via a user device; and
sharing information relating to the element with the receiving user via a network.

17. The method of claim 16, wherein identifying an element includes identifying an element and a corresponding physical location of the element.

18. The method of claim 16, further comprising the step of requesting permission from the administrator to share information relating to the element prior to sharing information relating to element with the receiving user.

19. The method of claim 18, further comprising the step of granting permission prior to sharing information relating to element with the receiving user.

20. The method of claim 16, wherein sharing information comprises sharing a description and/or quantity of samples within the element.
